(19) United States
(12) Patent Application Publication
(10) Pub. No.: US 2022/0017716 A1
(43) Pub. Date: Jan. 20, 2022

(54) ELECTRON BEAM IRRADIATED PRODUCT AND METHODS

(71) Applicant: MICON TECHNOLOGY, INC., Cambridge, MA (US)

(72) Inventors: Kaveh Bakhtari, Cambridge, MA (US); Oral Buyukozturk, Chestnut Hill, MA (US); Michael Philip Short, Cambridge, MA (US)

(21) Appl. No.: 17/294,471

(22) PCT Filed: Nov. 14, 2019
(86) PCT No.: PCT/US19/61471

§ 371 Date: May 17, 2021

Related U.S. Application Data
(60) Provisional application No. 62/769,892, filed on Nov. 20, 2018.

(51) Int. Cl. C08J 7/12; C04B 28/02; C04B 26/26; C04B 40/00

(52) U.S. Cl. CPC C08J 7/123; C04B 28/02; C08J 2300/00; C04B 40/0007; C04B 26/26

(57) ABSTRACT

This disclosure provides electron beam irradiated products and methods thereof. In particular, the invention is directed to a products and methods that comprise an electron beam irradiated component and a second component. The electron beam irradiated component may be plastic. The second component may be a building material or construction material. The invention is also directed to methods of manufacturing a modified polymer material with an electron-beam. Methods comprise irradiating the polymer particles of the material by dosing with electron beam radiation to produce a modified polymer material comprising irradiated polymer particles.

### CROSS-REFERENCE TO RELATED APPLICATIONS

The application claims priority to U.S. provisional application No. 62/769,892, filed on Nov. 20, 2018, the entirety of which is incorporated by reference.

### FIELD OF INVENTION

The invention relates generally to electron beam irradiated products and methods.

### BACKGROUND

Plastic is used every day in products around the world and consumers are encouraged to recycle plastic, resulting in the availability of high amounts of recycled plastic. In the United States alone in 2015, 34.5 million tons of plastic were generated, and 3.1 million tons of plastic were recycled. A way to repurpose the recycled plastic is to add the plastic to building materials or construction materials. Depending on the building material use, the plastic must go through additional processing in order to be a beneficial addition to the building material. For example, the plastic may be irradiated with gamma radiation in order to strengthen the plastic and provide additional support and structure in the building material. However, dosing the plastic with gamma radiation can be a time consuming, expensive process involving radioactive isotopes.

### SUMMARY

This disclosure provides electron beam irradiated products and methods thereof that are safe and cost effective. In particular, this disclosure describes irradiating recycled plastics with a dose of electron beam (e-beam) radiation. E-beam irradiation provides a method for quickly dosing plastic particles with radiation while decreasing safety concerns and decreasing costs by nearly ten-fold. E-beam irradiation sources use electrons to damage recycled plastics or polymers, thereby avoiding harmful radioactive isotopes. Electron beam irradiation cuts costs because electron beam emitters or irradiators are smaller and are more compact than gamma irradiators.

The e-beam radiation dose provided in this disclosure is sufficient to increase crystallinity and crosslinking of plastic, change contact angle and wettability, and produce functional groups and free radicals. These changes of the plastic, or polymer, produce observable changes in one or more properties of the polymer. For example, an increase in modulus, toughness, stiffness, and hardness may be observed. By adding the irradiated plastic particles as a filler or ingredient in building and construction materials, the irradiated plastic particles add strength and structure to the building materials.

The present invention may be used as an in-line system for polymer modification and production of the modified polymer material. The modified polymer material primarily consists of e-beam irradiated plastic, such as plastic waste, plastic flakes, plastic pellets, plastic particles, and plastic powder.

The present invention provides products comprising irradiated polymer particles. For example, methods of the invention may be carried out to produce irradiated plastic waste of a desired size. The irradiated plastic waste particles may be then used as an additive or filler in building and construction materials. By including the irradiated plastic particles in the building and construction materials, the plastic waste is repurposed. In addition, the building and construction materials are less expensive, due to using less of the original material and incorporating the additive of the irradiated plastic particles.

Any suitable electron beam machine or system may be used in methods of the invention. These machines may be developed exclusively for the purpose of producing the electron beam irradiated component of the claimed product in this patent. These systems may be developed for the sole purpose of such production by taking a sourced polymer and transforming the material into the electron beam irradiated component as an ingredient for construction material as well as structural and non-structural concrete elements. These machines may be specifically developed by integrating a commercially available electron generator into a unique system design with features that are included and manufactured to accomplish the methods of this invention.

In other instances methods of this invention may use electron beam machines and systems that are available commercially. Further, non-limiting examples of electron beam machines and systems are described in U.S. Pat. Nos. 5,612,588, 7,122,949, 4,954,744, 7,244,932, 6,327,339, and US Printed Publication No. 2002/0053353, each of which is incorporated herein in its entirety.

In the present invention, any suitable electron beam irradiator or electron beam emitter may be used. For instance, typical electron beam systems comprise electron beam emitters or electron beam irradiators, power supplies, machinery for bringing pre-irradiated material into the machine, systems for ensuring interaction of the pre-irradiated material with the electron beam, mechanisms to output the post-irradiated material from the machine, and a housing that contains all radiation-related hazards within the system. The e-beam emitter is a vacuum unit comprising a cathode that produces the electron beam. Electrons are released inside the emitter and an electric field is created inside the vacuum to accelerate these electrons into a beam. The electrons pass from the inside of the emitter, through a membrane separating the vacuum from the ambient air, and onto the target material for irradiation.

In some embodiments of the present invention, e-beam machines are specifically designed to handle polymers and modify polymer material by e-beam irradiation. The modified polymer material is used as an ingredient and a filler, or additive, in building and construction material. In certain embodiments, the invention is directed to a product comprising an electron beam irradiated component and a second component. Optionally, the product may comprise one or more additive materials.

Methods of the invention irradiate plastic or plastic waste using an e-beam machine. The plastic may optionally be shredded to the desired size pre-irradiation. In an embodiment, the plastic may optionally be pulverized to the desired size pre-irradiation. Therefore, any size of plastic waste may be used in methods of the invention. For larger size plastic, an apparatus and system of the invention may comprise a size reduction plastic modifier. Such a system may be designed as an in-line production system with an electron beam to produce shredded, or pulverized, and irradiated plastic.

An electron beam irradiated component may be any suitable material. For example, the electron beam irradiated component may be a polymer. In an example, the electron beam irradiated component is plastic. Any suitable plastic may be used, such as recycled plastic. For example, the plastic may be selected from the group consisting of plastic waste, plastic waste flakes, plastic pellets, plastic particles, and plastic powder.

Products of the invention may comprise asphalt, cement, concrete, cement paste, insulation material, building facing material, grout, and mortar. The second component may be a building material, a construction material, or any structural material. The building or construction material may be any suitable material used in building and construction, such as materials used in the production of asphalt, cement, concrete, cement paste, insulation material, building facing material, grout, and mortar.

In certain embodiments, the invention is directed to methods of manufacturing a modified polymer material with an electron-beam. The polymer particles of the material are irradiated by dosing the particles with electron beam radiation, thereby producing a modified polymer material comprising irradiated polymer particles. The material may be used as an additive to a construction material selected from the group consisting of asphalt, cement, concrete, cement paste, insulation, grout, and mortar. The method may comprise adding at least one additive to the material.

Polymer particles may comprise plastic selected from the group consisting of plastic waste, plastic waste flakes, plastic pellets, plastic particles, and plastic powder. In some embodiments, the method further comprises reducing a size of polymer particles in a material. For example, reducing the size of polymer particles in the material may comprise shredding and/or pulverizing the plastic. In some embodiments, shredding and/or pulverizing the plastic occurs before electron beam irradiation.

The method may further comprise influencing gas-plastic surface reaction with an ambient controller to result in changes in contact angle and wettability, production of functional groups and free radicals in addition to chain scission, and crosslinking in the plastic.

In certain embodiments, the invention is directed to methods for providing electron beam irradiated plastic. Plastic is provided to an electron beam irradiator. For example, the plastic is selected from the group consisting of plastic waste, plastic waste flakes, plastic pellets, plastic particles, and plastic powder.

Plastic may be moved through an electron beam path in the electron beam irradiator. The electron beam irradiator comprises a power source, a vacuum, and a cathode inside the vacuum for releasing electrons, wherein an electric field created inside the vacuum accelerates the electrons into a beam. The plastic is moved through the electron beam path in the electron beam irradiator in order to alter the plastic and form electron beam irradiated plastic. In some embodiments, the method may further comprise influencing gas-plastic surface reaction, for example, with an ambient controller.

Electron beam (e-beam) irradiated plastic is an output of the electron beam irradiator. The e-beam irradiated plastic may be used as an additive to a construction material selected from the group consisting of asphalt, cement, concrete, cement paste, insulation material, building facing material, grout, and mortar.

Electron beam irradiated products and methods of the invention provide a safer, faster way to irradiate plastic for use as an additive or filler in building or construction materials.

### BRIEF DESCRIPTION OF THE DRAWINGS

FIG. 1 shows a product according to an embodiment of the invention.

FIG. 2 shows a product according to an embodiment of the invention.

FIG. 3 is a flow chart of an exemplary method of forming a mixture including irradiated polymer particles according to an embodiment of the invention.

FIG. 4 is a flow chart of an exemplary method of forming e-beam irradiated plastic.

### DETAILED DESCRIPTION

Methods of the invention irradiate polymer, polymer waste, plastic or plastic waste using an e-beam machine and produce modified, irradiated plastic and polymer particles. The plastic may optionally be shredded and/or pulverized to the desired size pre-irradiation. Any suitable size of plastic waste may be used in methods of the invention. For larger size plastic, an apparatus and system of the invention may comprise a size reduction plastic modifier. The system may be designed as an in-line production system with an electron beam to produce shredded, or pulverized, and irradiated plastic.

In the present invention, e-beam machines may be specifically designed to handle polymers and modify polymer material by e-beam irradiation. The modified polymer material may be used as an ingredient or filler, or additive, in building and construction materials as well as structural and non-structural concrete elements. In some embodiments, the e-beam irradiated plastic particles may be used as an ingredient, filler, or additive, in materials used in applications other than building or construction industry.

The present invention may be used as an in-line system for polymer modification and production of the modified polymer material. The modified polymer material primarily consists of e-beam irradiation of plastic, such as plastic waste, plastic flakes, plastic pellets, plastic particles, and plastic powder.

Any suitable electron beam machine or system may be used in methods of the invention. Typical electron beam systems comprise electron beam emitters or electron beam irradiators, power supplies, machinery for bringing pre-irradiated material into the machine, systems for ensuring interaction of the pre-irradiated material with the electron beam, mechanisms to output the post-irradiated material from the machine, and a housing that contains all radiation-related hazards within the system. The e-beam emitter is a vacuum unit that produces the electron beam. Electrons are released inside the emitter and an electric field is created inside the vacuum to accelerate these electrons into a beam. The electrons pass from the inside of the emitter, through a membrane separating the vacuum from the ambient air, and onto the target material for irradiation. Outside the scope of the present invention, e-beam machines have been used for specific embodiments that cover a range of applications including surface sterilization for food and pharmaceutical packaging, curing and engineering material for printing and coating, and air treatment, among others.

The e-beam radiation dose provided in the invention is sufficient to make at least one of the following changes: increase in crystallinity and crosslinking of the plastic, change in contact angle and wettability, production of functional groups and free radicals. These changes of the plastic, or polymer, produce observable changes in one or more properties of the polymer. As an example, the dose of radiation may correspond to a dose sufficient to increase crystallinity of the polymer by greater than about 10 percent (e.g., greater than about 15 percent). Crystallinity changes may be useful, for example, for producing observable changes in one or more properties of the polymer. For example, changes include an increase in one or more of the modulus, toughness, stiffness, and hardness of the polymer.

Further, the dose of radiation may be a function of any one or more of various different factors. For example, the radiation dose may be a function of the composition of the polymer and the targeted compression strength of the building or construction material including the particles of the polymer in the irradiated state. The inclusion of the electron beam irradiated component may allow for a mix adjustment that will result in overall benefits. For example, the irradiated plastic particles may add strength and structure to the building and construction materials. In other instances, the overall benefit may be a reduction in cement content per m³ of concrete, thus providing a benefit of sustainability reduced carbon-footprint. In other aspects of the invention, the overall benefit may be increased compressive strength and other mechanical properties of concrete, such as, increased durability of the concrete.

In certain aspects, the invention is directed to a product comprising an electron beam irradiated component and a second component. The electron beam irradiated component is plastic. The second component is a building material or construction material as well as structural and non-structural concrete elements. In some embodiments, the e-beam irradiated plastic particles may be used as an ingredient, filler, or additive in materials used in applications other than building or construction industry.

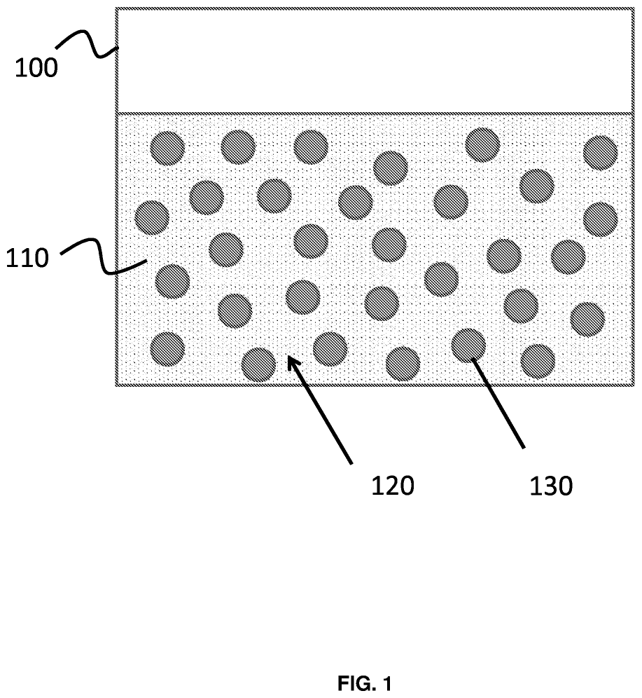

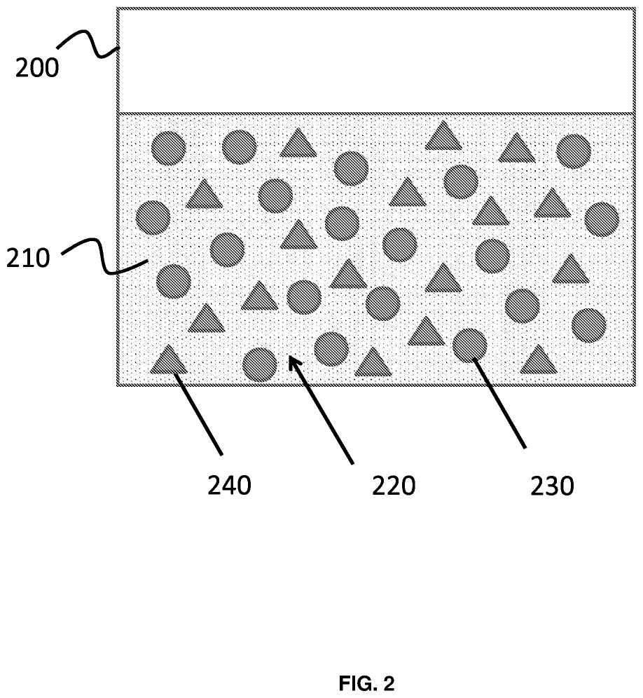

FIGS. 1 and 2 show products according to exemplary embodiments of the invention. FIG. 1 shows a receptacle 100 containing a product 110 according to an embodiment of the invention. The product 110 comprises irradiated polymer particles 130 and a second material 120. FIG. 2 shows a receptacle 200 containing a product 210 according to an embodiment of the invention. The product 210 comprises irradiated polymer particles 230, a second material 220, and at least one additive 240.

Certain embodiments of the invention comprise methods for e-beam irradiation of a material. For example, the material may comprise a polymer or polymer particles. The polymer or polymer particles may be plastic or plastic waste. The plastic or plastic waste may comprise pulverized plastic, shredded plastic, plastic pellets, plastic flakes, and plastic powder. Methods of the invention comprise providing the plastic into a machine and through an electron beam path in the machine. This results in the interaction of the polymer with the e-beam. The e-beam alters the plastic bulk and surface. The altered plastic product exits the machine and may be used as an additive to construction material. Some embodiments comprise shredding the plastic to the desired size prior to the irradiation process. Some embodiments comprise pulverizing the plastic to the desired size prior to the irradiation process.

In certain aspects, the invention is directed to methods of manufacturing a modified polymer material with an electron-beam irradiator. The methods comprise irradiating the polymer particles of the material by dosing with electron beam radiation, thereby producing a modified polymer material comprising irradiated polymer particles.

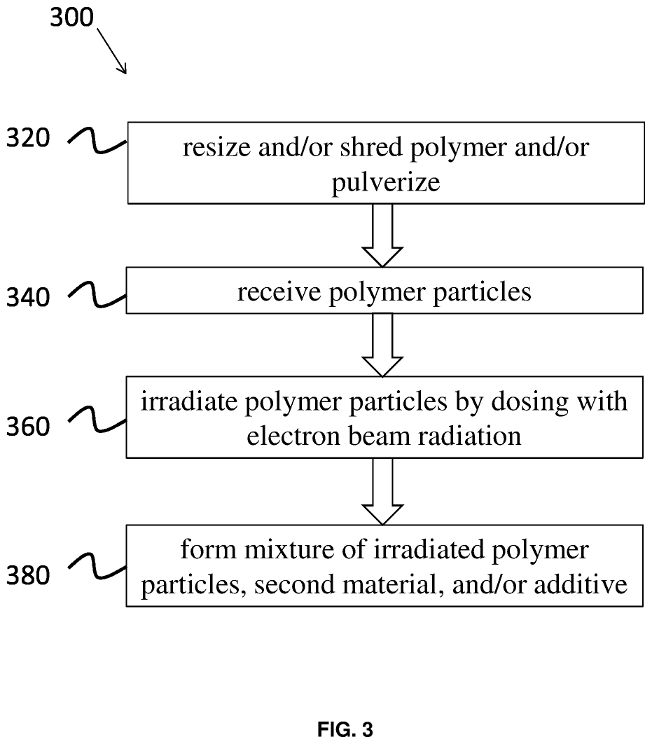

FIG. 3 shows a flow chart of an exemplary method 300 of forming a mixture of irradiated polymer particles, second material, and/or additive. The method may include resizing and/or shredding or pulverizing the polymer to a predetermined size 320. The polymer particles are then received by an e-beam irradiator 340. The polymer particles are irradiated by dosing with electron beam radiation 360. The mixture of irradiated polymer particles, second material, and/or an additive is then formed 380.

In certain aspects, the invention is directed to methods for providing electron beam irradiated plastic. The methods comprise providing plastic to an electron beam irradiator; moving the plastic through an electron beam path in the electron beam irradiator to alter the plastic and form electron beam irradiated plastic; and outputting the electron beam irradiated plastic from the electron beam irradiator.

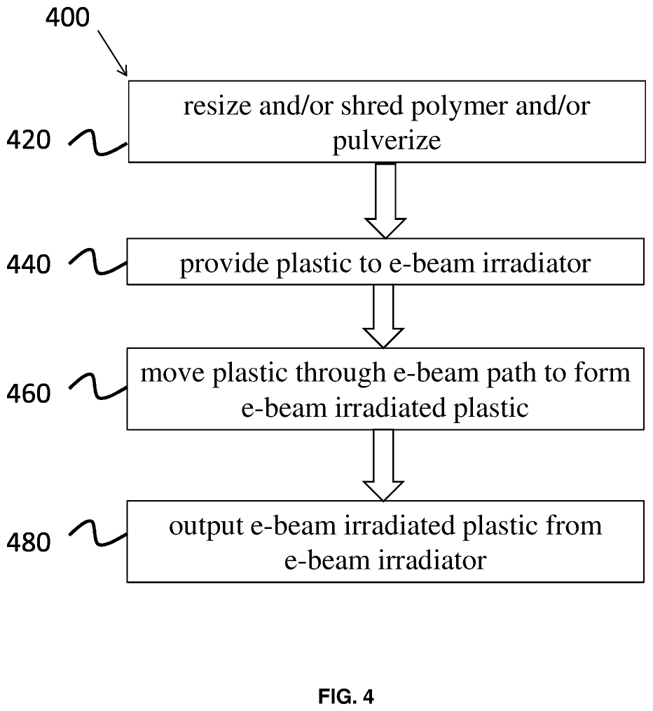

FIG. 4 shows a flow chart of an exemplary method 400 of forming e-beam irradiated plastic from an e-beam irradiator. The method may include resizing and/or shredding or pulverizing plastic 420. The plastic is provided to an e-beam irradiator 440. E-beam irradiated plastic is formed by moving the plastic through the e-beam path 460. The e-beam irradiated plastic is then output from the e-beam irradiator 480.

In certain aspects of the invention, a system is provided for irradiating polymer particles. Any suitable polymer particles may be used. For example, the polymer may be plastic and the plastic may comprise pulverized plastic, shredded plastic, plastic pellets, plastic flakes, and plastic powder.

These systems may be developed exclusively for the purpose of producing the electron beam irradiated component of the claimed product in this patent.

Systems of the invention may comprise a machine comprising one or more electron emitters or electron beam irradiators. For example, electron emitters may comprise an electron source inside a vacuum chamber, a power supply to generate a stream of accelerating electrons leaving the source, and an electron window allowing the electrons to exit the emitter.

Systems of the invention may further comprise moving parts that input the plastic into the machine. The moving parts may expose the plastic to the electron beam by creating a relative motion between the emitters and the plastic material. The moving parts may further output the irradiated product.

In an embodiment, the relative movement mechanism between the emitter and passing plastic is gravity-assisted movement of the plastic particles. An air knife and/or guides and control mechanisms may be provided to ensure uniformity of thickness of the falling plastic in the gravity mode.

In an embodiment, the relative movement mechanism between the emitter and passing plastic is passed over a conveyor belt or carried in containers that pass under the beam. In such an embodiment, the conveyer belt may be vibrated to ensure the plastic particles change orientation when passing under the beam. The particles may be provided in a single layer or in multi-layers, and the beam voltage and air gap will dictate the dose received throughout the plastic particle as well as throughout the layer of particles.

Systems of the invention may further comprise a controller. For example, systems of the invention may comprise a controller that modulates a delivered electron beam dose rate by varying one or more parameters. Examples of parameters include varying speed, changing emitter beam output, and changing distance between the emitter and the plastic.

Systems of the invention may further comprise safety and/or protective equipment. For example, x-ray shielding may be provided in order to protect the workers, the general public, and the environment against unnecessary radiation from accelerator operations.

In an embodiment, systems of the invention may further comprise an ambient control mechanism. The ambient control mechanism may be external to the emitter and internal to the machine. The ambient control mechanism may influence the gas-plastic surface chemical reaction in addition to the electron bombardment chain scission and crosslinking.

In some embodiments, systems of the invention further comprise an integrated system for mechanical alteration of the plastic prior to irradiation. For example, the plastic may be pulverized, shredded, flaked, and formed into a powder prior to irradiation.

In some embodiments, the present invention is directed to a system for e-beam irradiation. For example, a system may include a processing unit, material sources, a receptacle, a mixer, a hydration source, and a controller. In use, the controller may be in communication with one or more of the processing unit, the material sources, the mixer, and the hydration source to form particles of a polymer into an irradiated form and to mix the particles of the polymer in the irradiated form with at least a second material and/or an additive to form a building material or construction material in the receptacle. Because the particles of the polymer in the irradiated form may be derived from one or more sources (e.g., e-beam irradiation of plastic, such as recycled plastic) associated with greenhouse gas emissions lower than those associated with the second material, replacing a portion of the second material in a given volume with the particles of the polymer in an irradiated form may result in the building material or construction material being useful as an environmentally responsible substitute for traditional building and construction materials.

In some embodiments, the system may have substantially fixed operating parameters useful for forming a predetermined composition of the building or construction material, with such substantially fixed operating parameters being useful in large-scale manufacturing. In certain implementations, however, the system may have one or more adjustable operating parameters useful for modifying composition of the build material, such as may be useful for varying formulation of the build material to accommodate specific criteria.

In general, the processing unit may include a radiation source (such as an e-beam irradiator) positioned to direct a controlled dose of radiation to the particles of the polymer in a volume defined by the processing unit. As a more specific example, a e-beam irradiator facility may deliver radiation at a rate (e.g., in kGy/sec, as opposed to Gy/min in gamma systems) suitable for radiating the particles of the polymer within a prescribed time (e.g. less than 1 minute) compatible with high-volume production on a commercial scale. In this work, we have achieved full-range processing of 1 mm plastic particles in less than 10 seconds.

In certain implementations, the processing unit may include a grinder in communication (e.g., through a gravity feed, a conveyor, or a combination thereof) with the volume such that material processed in the grinder is movable into the volume for irradiation. The grinder may receive a raw form (e.g., flakes) of the particles of the polymer in a non-irradiated form and, further or instead, may mechanically reduce the size of the raw form of the particles of the polymer. The grinder may process a raw form of the particles of the polymer to achieve any suitable size distribution. For example, the grinder may process the raw form of the particles of the polymer to achieve a size distribution having an average particle size greater than about 100 microns and less than about 200 microns. The grinder may include, for example, a ball mill. As a more specific example, the grinder may include a high energy ball mill. Additionally, or alternatively, the grinder includes other hardware suitable for crushing the particles of the polymer. While the grinder has been described as grinding the particles of the polymer prior to irradiation, it should be appreciated that the grinder may additionally or alternatively be positioned to grind the particles of the polymer following irradiation.

The volume defined by the processing unit may be in communication with one or more of the material sources such that, following irradiation, the particles of the polymer in an irradiated form may be movable into the respective one or more of the material sources. Movement of the particles of the polymer in the irradiated form from the volume and into the one or more material sources may be carried out according to any of various different techniques suitable for safely and efficiently moving the particles of the polymer. For example, the irradiated polymer particles may be moved from the volume and into one or more of the material sources through movement of a conveyor extending from the volume to the one or more material sources.

In certain embodiments, the material sources may each store an individual component of the building or construction material prior to forming the building or construction material in the receptacle. Thus, for example, the irradiated polymer particles may be stored in the material source. Additionally, or alternatively, the building or construction material may be stored in the material source. Further, the at least one additive may be stored in the material source. While such segregation of components in the respective material sources may be useful for controlling the compositional accuracy of the building or construction material, it should be appreciated that other storage techniques are within the scope of the present disclosure. Thus, for example, multiple components of the building or construction material may be stored in a single one of the material sources at the same time, as may be useful for premixing certain combinations of components (e.g., premixing the cement and at least one additive).

The material sources may be any of various different types of containers suitable for stably storing the components of the building or construction material. As used in this context, stable storage of material may include reducing the likelihood of unintended aggregation, settling, and/or hydration of each respective component. For example, the material sources may be hoppers supported above the receptacle. The material sources may each include respective valves. Each of the valves may be selectively actuatable to control delivery of the respective contents of the respective one of the material sources. Further, each of the valves may include a metered orifice to facilitate accurately metering the flow of material from the respective one of the material sources into the receptacle.

In general, the receptacle may be of a size and shape suitable for supporting mixing of the contents of the building or construction material in quantities required for a particular manufacturing process. Further, or instead, the receptacle may be formed of a material (e.g., steel) suitable for withstanding corrosion or other forms of degradation that may be associated with the building or construction material.

The mixer may be disposed in the receptacle to facilitate mixing the constituent components of the build material into a homogenous mixture. As used herein, a homogenous mixture shall be understood to include small variations in homogeneity such that the volumetric composition of the build material varies by less than about ±5 percent (e.g., less than about ±1 percent) within the receptacle. The mixer may be any one or more of various different types of mechanisms useful for combining the constituent components of the build material. Thus, for example, the mixer may include a rotor or other similar component substantially submersible in the build material and movable relative to the receptacle to mix the components of the build material. Additionally, or alternatively, the receptacle itself may move (e.g. through rotation, vibration, or a combination thereof) to mix the components of the build material. Thus, it should be more generally understood that the constituent components of the build material may be formed into a homogeneous mixture through any one or more of various different forms of mechanical agitation. Further, or instead, in instances in which a sufficient amount of hydration is introduced into the build material in the receptacle, the constituent components of the build material may further or instead be mixed through the flow of water in the receptacle.

In general, the controller may include one or more processors and a non-transitory, computer-readable medium having stored thereon computer executable instructions for causing the one or more processors to communicate with one or more other components of the system according one or more aspects of any one or more of the methods described in greater detail below. While the controller may be single controller, the instrument may be implemented as a plurality of distributed controllers (e.g., operable individually), such as may be useful for controlling individual aspects of the system, particularly in instances in which the system is itself distributed across multiple locations. Such distributed controllers may be in communication with one another (e.g., through a data network).

In certain implementations, the controller may be in electrical communication with the valves to control dispensing of the particles of the polymer, the cement, and the at least one additive into the receptacle in controlled proportions relative to one another. Additionally, or alternatively, the controller may be in electrical communication with the mixer to control movement (e.g., a rotational speed, a rotational direction, or a combination thereof) of the mixer.

Further, the controller may be in electrical communication with the hydration source to control a rate or a total amount of water flow into the receptacle such that a target amount of moisture may be introduced into the build material as desired for a particular application. The controller may further be in electrical communication with the processing unit to control one or more different aspects of preparation of the particles of the polymer. For example, the controller may control actuation of the grinder to form the particles of the polymer into a target size distribution. As an additional or alternative example, the controller may control movement of the particles of the polymer into and out of the volume defined by the processing unit to control the amount of radiation delivered to form the irradiated polymer particles.

### Comparison of Gamma Radiation to Electron Radiation

In some instances, polymers or plastics are irradiated with gamma irradiation. However, electron irradiation is desirable for a number of reasons. For example, electron radiation delivers a faster dose (kGy/sec compared to Gy/min). Electron radiation is a cost-sensitive option, as the cost per machine vs. processing facility is approximately a One hundred-fold decrease in price. Electron radiation also provides the ability to locate electron irradiation machines at partner facilities. Furthermore, there are fewer regulations required to own and/or operate electron irradiation sources, due to the lack of radioactive isotopes. In contrast, gamma sources must contain an actively decaying isotope of considerable quantity and danger.

### Comparing Damaging Power of Photons and Electrons

When comparing the mechanics of electron beams and gamma rays, electrons cause far more damage to polymers per ion, per distance traveled compared to gamma rays.

Much of this has its origins in the cross sections for gamma and electron interactions, or the per-incident particle probabilities that any interaction will happen. Many cross sections exist for every type of reaction with every type of incident particle—each is independently measured or tabulated depending on these parameters. This allows for a 1:1 comparison of, for example, the probability that a gamma ray will cause damage per unit distance compared to an electron. For this, NIST databases ESTAR (Electron STopping And Range in matter) and X-Ray Mass Attenuation Coefficients were used, which together paint a picture of how quickly each particle loses energy traversing the same medium. For this example, polyethylene is considered, a typical plastic widely used with a density of about 0.86 g/cm³. Gammas and electrons of the same energy are considered, and here are taken as 1 MeV.

In this calculation, the dose rates are calculated, assuming the same flux of both types of radiation (gammas and electrons), at the same energy, in the same medium. This will give a comparison of the effectiveness of each type of radiation at causing damage.

The NIST X-Ray Mass Attenuation Coefficients database gives a mass attenuation coefficient of 0.0726 cm²/g to be used in the equation:

$$I = {I}_{0} {e}^{- ( \frac{μ}{ρ} ) ρ x}$$

In the equation above, I is the intensity of a beam (originally I₀) traversing a distance x through a medium with density ρ and mass attenuation coefficient (μ/ρ). The quantity

$$( \frac{μ}{ρ} ) ρ$$

is called the attenuation coefficient, in units of cm⁻¹, and therefore its inverse can be taken as the mean free path of the photons between interactions.

For about 1 MeV photons in polyethylene, this comes to about 13.8 cm. This physically means a few things for the irradiation of plastic with gamma rays. In particular, gamma rays are weakly interacting with polyethylene (and all matter, for that matter), requiring thick volumes to efficiently use the gamma ray energy. Further, the matter to be irradiated will be unevenly irradiated unless rotated during irradiation. Also, the irradiation will take an extremely long time.

Gamma rays interact with the electrons in matter, assuming energies below a few MeV. The mechanism can be any of the photoelectric effect (absorption of the photon, ejection of an electron), Compton scattering (scattering off an electron with its subsequent ejection), or pair production (creation of an electron/positron pair). If it is assumed (conservatively) that every gamma ray interacts with matter via the Photoelectric Effect, depositing all of its energy, then the dose rate from a beam of 1 MeV gamma rays with flux Φ (in photons/cm²s) is given as:

$$\dot{G} y = \frac{G y}{s e c} = \frac{J}{kg - sec} = {E}_{γ} Φ N σ = \frac{{E}_{γ} Φ N \frac{( \frac{μ}{ρ} ) M M}{{N}_{Avogadro}}}{ρ}$$

In the equation above, MM is the molar mass of an average polyethylene monomer, N_{Avogadro} is Avogadro's number (6.023*10²³ atoms/mole), N is the number density of polyethylene monomers per unit volume (about 1.1*10²² monomers/cm³), σ is the microscopic cross section,

$$( \frac{μ}{ρ} )$$

is the mass attenuation coefficient for polyethylene as found on the NIST database, and E_{γ} is the energy of the photon in Joules (note that 1 MeV=1.6*10⁻¹³ J).

Using values for embodiments of the present invention, and assuming a gamma ray flux of about 10¹⁴ photons/cm²s, a dose rate is about 0.00035 Gy/sec. Note here that the density of polyethylene was used in kg/cm³ to arrive at a dose rate in Gy/sec. Because of the very low dose rate, a batch process is required in order to effectively irradiate plastic with gamma rays, plus rotation and mixing to ensure even irradiation. It should be noted that with a mean free path of about 13.8 cm, a batch thickness of a few cm would be almost evenly irradiated, with a slowly, but exponentially, decreasing dose rate as a function of distance into the plastic.

The same quantity is calculated for electrons. In an embodiment, the ESTAR database may be used to find a stopping power and range for 1 MeV electrons. A mass-normalized range is about 0.4155 g/cm², and upon dividing by the density of polyethylene, we get a path amount of about 0.489 cm, just under about 5 mm.

Q. Yan and L. Shao, 2017, J. Nuclear Materials, 485:98-104, the contents of which are incorporated herein in entirety, provides an explanation of how much energy is deposited by about 1 MeV electrons as a function of depth into the material. Energy deposited by about 1 MeV electrons in pure Fe is discussed in the Yan and Shao article. Such a curve would stretch by about a factor of about eight in polyethylene, depositing significant energy over a range of about 2.5 mm. Simply noting that an about 1 MeV electron deposits the bulk of its energy (about 1-1/e, or about 63%) in such a short distance, a simple scaling calculation gives a dose rate of about 0.019 Gy/sec for the same parameters when simply substituting out the gamma for the electron. In other words, an electron is about 55.2× more effective at transferring energy per unit length compared to a gamma ray of this equivalent energy.

Modified Calculation Comparing 1 MeV Photons with 200 keV Electrons

Most commercial electron emitters release electron irradiation at roughly 150-250 keV, thus a comparison of the two types of particles to be used is warranted. The ESTAR tables from NIST give a mass normalized range of about 0.04215 g/cm², which correspond to a particle range of about 0.036 cm (about 360 microns). Most of the energy is deposited in the first half of the range, meaning that a particle size of roughly 170 microns would be uniformly and most efficiently irradiated by an about 200 keV electron beam. Using the same scaling relation used above, this results in an about 200 keV electron being about 77 times as damaging as an about 1 MeV gamma ray per particle, assuming an inline plastic layer thickness of about 170 microns.

### Higher Damaging Power of Electrons

The damaging power of electrons depends strongly on the energy of the gamma rays, so one could “debunk” this argument by simply saying one should compare low-energy gamma rays (˜10-200 keV), which have photoelectric effect cross sections 10-1000× higher than those at 1 MeV.

However, most gamma irradiators emit gamma rays in the 1 MeV range. In other words, isotopes which emit lower energy gamma rays are not commonly extracted from reactors or intentionally bred. A notable exception exists for ^{99m}Tc, used for medical imaging on account of its 6 day half-life.

Further, the combination of low energy gamma ray, high activity (for high flux), and high half-life is exceedingly rare, especially among the materials used in reactors or derived from stable elements. A high half-life and high activity simply requires a large amount of material.

Gamma ray sources are only as intense as they are made, and their strength decays exponentially with time. In contrast, electron sources can either be made to (1) output more current with more power, or (2) put in parallel to irradiate larger volumes.

Furthermore, the electron beam irradiation route lends itself directly to in-line irradiation due to the higher cross sections of interactions (and therefore lower ranges) of electrons compared to photons.

In addition, a number of unique aspects of the energy density of electron irradiation confer additional chemical changes when irradiating plastic, particularly in cover gases containing oxygen and nitrogen, such as air. Electron irradiation causes ionizations in the air, creating free radicals which directly or indirectly through their reactions create highly chemically active species, such as ozone, hydrogen peroxide (in the presence of water vapor), and sulfur/nitrogen oxide compounds. These compounds further alter the chemical structure of the surface of the plastic particles, changing it from a normally inert, single-bonded hydrogen-terminated surface to a more complex mixture of surface termination structures and dangling bonds. In certain embodiments, it is to these new surface structures that phases within cement, the continuous phase in concrete, can take better root and bind strongly to the plastic. Though this effect does occur with gamma irradiation, a stronger effect is shown with electron irradiation.

### Wider Range of Doses and Fill Fractions

When using electron-irradiated plastic, such as for a filler, or additive, for construction materials, a far wider range of doses and fill fractions than those tested thus far is possible. This is due to the presence of strong dose rate effects in radiation damage. For instance, in metals, increasing the dose rate incurs less damage per particle (not per unit time), such that a higher total fluence or energy deposition may be required to incur the same damage. This is partially due to overlapping damage cascades (for the case of heavier charged and uncharged particles), smaller inter-cascade recombination radii, and in extreme cases, elevated temperature and thereby faster defect diffusion.

In the present invention, it is expected that such dose rate effects will occur, shifting the optimum dose of electron irradiation, applied 10-1000× faster than current testing, to a much higher dose. A rule of thumb borrowed from the field of irradiation damage in metals is that an order of magnitude increase in dose rate may decrease per-particle damage by about a factor of two. Further testing is necessary to determine whether such a guideline will apply in polymers.

Embodiments of the invention comprise any suitable dose of electron beam irradiation. In some instances, doses range from about 1 kGy to about 1000 kGy. In some instances, 1000 kGy of damage may severely weaken the structure of the plastic. Furthermore, in certain embodiments, doses of 1 kGy may confer no beneficial effect.

Embodiments of the invention comprise any suitable fill fraction for use in any suitable building material or construction material. In some instances, the fill fraction is about 0% to about 5% by weight of the building material or construction material. In certain examples, the fill fraction by weight of building material or construction material 0.5-10% by weight of the cementitious material portion of concrete.

In some embodiments, the electron beam irradiated component is plastic. The invention may comprise any suitable plastic. For example, in some embodiments, the plastic is selected from the group consisting of plastic waste, plastic waste flakes, plastic pellets, and plastic particles.

In some embodiments, the second component is a building material or construction material. The building material or construction material may be any suitable material. In some examples, the building material or construction material comprise asphalt, cement, concrete, cement paste, insulation, grout, and mortar.

The fill fraction by weight is affected by the size effect of particles. Smaller particles have proportionally more surface area, and thus will bond more strongly to the surrounding cementitious matrix. Smaller particles will also likely induce the formation of more and stronger phases such as gismondine, conferring additional strength. In some embodiments, for example, the particle size is about 100 um, allowing for a fill fraction of about 5%. This fill fraction is feasible with a good dispersion of particles, as the cementitious phase would still be quite continuous.

Therefore, 200 keV electrons are over 75× more damaging per particle compared to 1 MeV photons. Numerous additional benefits exist when using electron irradiation. For example, benefits may include increased surface modification, better uniformity of applied damage, and continuously variable beam energy and current.

The cost of an equivalent facility shrinks by 100× when using an electron beam compared to a gamma facility. The cost reduction is multiplied by the absence of shielding, licensing, regulation, and radiation protection requirements. The cost reduction is also due to the very short range of electrons.

Dose rate effects are likely to shift the optimum electron irradiation dose significantly higher than gamma optimum of 50 kGy, thus allowing for a far wider range of doses. Higher fill fractions are possible due to the suitability of e-beam irradiation to uniformly irradiate plastic nanoparticles in-line.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### EQUIVALENTS

While the present invention has been described in conjunction with certain embodiments, one of ordinary skill, after reading the foregoing specification, will be able to effect various changes, substitutions of equivalents, and other alterations to the compositions and methods set forth herein.

1. A product comprising:
an electron beam irradiated component; and
a second component.

2. The product of claim 1, wherein the electron beam irradiated component is plastic.

3. The product of claim 2, wherein the plastic is selected from the group consisting of plastic waste, plastic waste flakes, plastic pellets, plastic particles, and plastic powder.

4. The product of claim 1, wherein the second component is a building material or construction material.

5. The product of claim 1, wherein the product is asphalt.

6. The product of claim 1, wherein the product is cement.

7. The product of claim 1, wherein the product is concrete.

8. The product of claim 7, wherein the electron beam irradiated component allows for a mix adjustment that provides a displacement of a portion of chemical admixture content per m³ of concrete.

9. The product of claim 7, wherein the electron beam irradiated component allows for a mix adjustment that provides a displacement of a portion of cement content per m³ of concrete.

10. The product of claim 1, wherein the product is cement paste.

11. The product of claim 1, wherein the product is insulation material or building facing material.

12. The product of claim 1, wherein the product is grout.

13. The product of claim 1, wherein the product is mortar.

14. A method of manufacturing a modified polymer material with an electron-beam comprising:
irradiating polymer particles of a material by dosing the material with electron beam radiation, thereby producing a modified polymer material comprising irradiated polymer particles.

15. The method of claim 14, wherein the polymer particles comprise plastic selected from the group consisting of plastic waste, plastic waste flakes, plastic pellets, plastic particles, and plastic powder.

16. The method of claim 15, further comprising reducing a size of polymer particles in the material.

17. The method of claim 16, wherein reducing the size of polymer particles in the material comprises shredding or pulverizing the plastic.

18. The method of claim 17, wherein shredding or pulverizing the plastic occurs before electron beam irradiation.

19. The method of claim 14, further comprising adding at least one additive to the material.

20. The method of claim 14, further comprising influencing a gas-plastic surface reaction with an ambient controller by at least one of a change in contact angle and wettability, a production of functional groups and free radicals, or electron bombardment chain scission and crosslinking.

21-27. (canceled)
